(19) United States
(12) Patent Application Publication
(10) Pub. No.: US 2022/0108412 A1
(43) Pub. Date: Apr. 7, 2022

(54) ADAPTIVE AUTONOMOUS NEGOTIATION METHOD AND SYSTEM OF USING

(71) Applicant: NEC Corporation, Tokyo (JP)

(72) Inventors: Ayan SENGUPTA, Kanagawa (JP); Yasser Farouk Othman MOHAMMAD, Kanagawa (JP)

(21) Appl. No.: 17/184,590

(22) Filed: Feb. 25, 2021

Related U.S. Application Data
(60) Provisional application No. 63/088,452, filed on Oct. 7, 2020.

(51) Int. Cl. G06Q 50/18; G06K 9/62; G06N 20/00

(52) U.S. Cl. CPC G06Q 50/188; G06N 20/00; G06K 9/6262

(57) ABSTRACT

A method of adaptive autonomous negotiation includes receiving a first offer, using a receiver. The method further includes automatically identifying a first negotiator of a plurality of negotiators, using a processor, based on the received first offer, wherein the plurality of negotiators is stored in a memory. The method further includes automatically selecting a first strategy from a plurality of strategies based on the identified first negotiator, wherein the plurality of strategies is stored in the memory. The method further includes automatically selecting an action for responding to the first offer based on the selected first strategy, wherein automatically selected the action includes performing an inverse mapping on the selected first strategy. The method further includes automatically transmitting the selected action, using a transmitter.

### PRIORITY CLAIM AND CROSS-REFERENCE

This application claims priority to Provisional Application No. 63/088,452, filed Oct. 7, 2020, which is hereby incorporated by reference in its entirety.

### BACKGROUND

As commerce using the Internet has increased, autonomous negotiations have also increased. Autonomous negotiation utilizes artificial intelligence (AI) in place of human negotiators in order to attempt to reach agreements between parties. AI is used to evaluate an offer from an opponent and then determine a response to the offer. In some instances, the response is a counter-offer. In some instances, the response is acceptance of the offer. In some instances, the response is to end the negotiation.

In some approaches, an AI negotiator is selected based on the issues to be negotiated, a first offer from the opponent, and priorities of the user, i.e., self-utility values. The selected AI negotiator is maintained throughout the negotiation process. The selected AI negotiator remains constant regardless of whether the opponent changes strategy.

In some approaches, an online method of negotiation is used to identify a strategy from a group of strategies based on multiple negotiations with a same opponent. Multiple negotiations are used in order to identify the strategy which obtains a best result against a specific opponent. For each opponent, additional negotiations are used to identify which strategy from the group of strategies works best with each opponent.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a negotiation using an adaptive autonomous negotiation method in accordance with some embodiments.

FIG. 2 is a flowchart of a method of negotiation using an adaptive autonomous negotiation method in accordance with some embodiments.

FIG. 3 is a schematic view of an adaptive autonomous negotiation system in accordance with some embodiments.

FIG. 4 is a flowchart of a method of adding a new negotiator or a new strategy to an adaptive autonomous negotiation system in accordance with some embodiments.

FIG. 5 is a schematic view of an adaptive autonomous negotiation system in accordance with some embodiments.

FIG. 6 is a block diagram of a system for adaptive autonomous negotiation in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

In order to maximize the benefit of an autonomous negotiator, the autonomous negotiator should have the ability to adapt to a change in strategy from an opponent. For example, in other approaches, if offers from the opponent become more aggressive during a negotiation, then maintaining a same strategy throughout the entire negotiation increases the risk of a poor result or a failure to reach an agreement entirely. By using artificial intelligence (AI) to adapt the strategy for responding to a new offer from an opponent, the chance of obtaining a positive result and reaching an agreement increases. In some embodiments, the AI takes into account one or more previous offers during the negotiation in order to determine whether the opponent has changed strategies, which would in turn prompt the AI to determine whether to change a response strategy. By using the AI, the negotiation is able to proceed without interference or interaction by a user. That is, in some embodiments, all operations are performed automatically without input from the user.

The benefit of an autonomous negotiator is also maximized by permitting the AI to consider and incorporate new strategies and negotiators into the group of available strategies and negotiators for responding to offers from an opponent. In other approaches where the available strategies and negotiators are static, the AI may be unable to achieve a positive result from the negotiation if none of the available strategies are suitable for responding to the opponent offers. The ability to evaluate the desirability of a new strategy or negotiator helps the AI to continue to produce positive results as the opponent also evolves.

In this application, a negotiator is a multi-component element. A negotiator is a rule based element, which contains a strategy within. The negotiator is usable for modeling the opponent. That is, the negotiator is used to try to match the priorities, i.e., utility values, for the opponent. In contrast, a strategy is a single component element. A strategy is the determination of how to respond to the offer from the opponent.

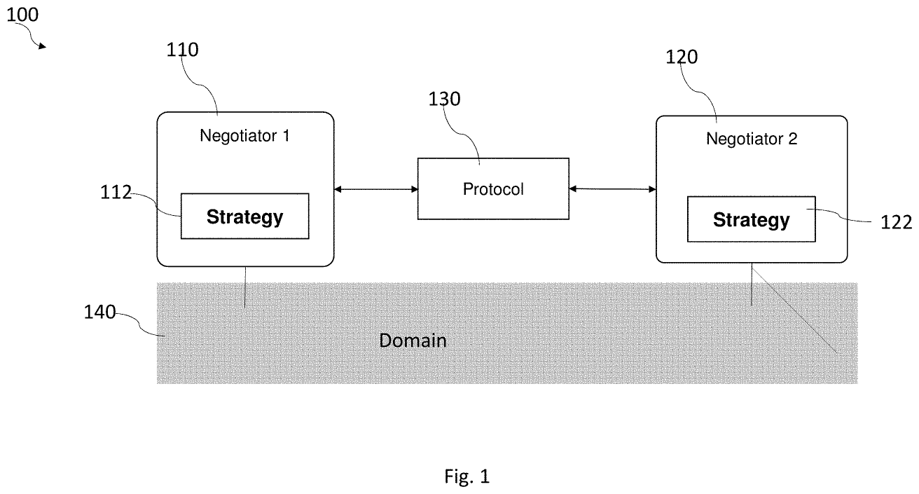

FIG. 1 is a schematic view of a negotiation 100 using an adaptive autonomous negotiation method in accordance with some embodiments. The negotiation 100 includes a first negotiator 110 including a first strategy 112. The negotiation 110 includes a second negotiator 120 including a second strategy 122. A protocol 130 is used to determine the style of negotiation between the first negotiator 110 and the second negotiator 120. A domain 140 includes the issues to be resolved in the negotiation 100. The negotiation 100 is a bilateral negotiation. However, the current disclosure is not limited to only bilateral scenarios.

The first negotiator 110 includes AI algorithms for determining priorities for the issues to be resolved. These priorities are captured in utility values associated with each of the issues to be resolved. That first negotiator 110 uses these utility values to priorities possible outcomes from the negotiation 100. The first negotiator 110 is able to communicate with the second negotiator 120 using the protocol 130. In some embodiments, the first negotiator 110 is able to communicate wireles sly. In some embodiments, the first negotiator 110 is able to communicate using a wired connection. In some embodiments, the first negotiator 110 is able to communicate via the Internet. The first negotiator 110 is able to transmit an offer, counter-offer, acceptance or rejection to the second negotiator 120. The first negotiator 110 is autonomous, i.e., operating without user input or control.

The first strategy 112 is the action determined by the first negotiator 110 based on the utility values and algorithm used by the first negotiator 110. In some embodiments, the first strategy 112 includes an offer, a counter-offer, an acceptance or a rejection. In some embodiments, the first strategy 112 changes during the negotiation 100 based on new information received from the second negotiator 120.

The second negotiator 120 includes AI algorithms for determining priorities, captured using utility values, for the issues to be resolved. The second negotiator 120 is able to communicate with the first negotiator 110 using the protocol 130. In some embodiments, the second negotiator 120 is able to communicate wirelessly. In some embodiments, the second negotiator 120 is able to communicate using a wired connection. In some embodiments, the second negotiator 120 is able to communicate via the Internet. The second negotiator 120 is able to transmit an offer, counter-offer, acceptance or rejection to the first negotiator 110. In some embodiments, hardware for the first negotiator 110 is the same as the hardware for the second negotiator 120. In some embodiments, hardware for the first negotiator 110 is different from the hardware for the second negotiator 120. In some embodiments, the algorithms implemented in the first negotiator 110 are the same as the algorithms implemented in the second negotiator 120. In some embodiments, the algorithms implemented in the first negotiator 110 are different from algorithms implemented in the second negotiator 120. In some embodiments, the second negotiator 120 is autonomous. In some embodiments, the second negotiator 120 is controlled based on user input.

The second strategy 122 is the action determined by the second negotiator 120 based on the utility values and algorithm used by the second negotiator 120. In some embodiments, the second strategy 122 includes an offer, a counter-offer, an acceptance or a rejection. In some embodiments, the second strategy 122 changes during the negotiation 100 based on new information received from the first negotiator 110.

The protocol 130 is the rules for the negotiation 100. For example, in an alternating offers protocol, the negotiators, e.g., the first negotiator 110 and the second negotiator 120, exchange offers in an alternating fashion. In some embodiments, the protocol 130 is an alternating offers protocol. In some embodiments, the protocol 130 is a different protocol, such as time based offers, or other suitable protocols. The protocol 130 is established prior to beginning the negotiation 100 so that the first negotiator 110 and the second negotiator 120 know when and whether an offer or reply should be transmitted. In some embodiments, the protocol 130 includes a maximum number of steps, e.g., offers. In some embodiments, the protocol 130 includes a time limit for the negotiation 100.

The domain 140 includes the issues to be resolved. For example, the issues to be resolved, in some embodiments, include price, quantity, brand name, etc. In some embodiments, the domain 140 includes a single issue. In some embodiments, the domain 140 includes multiple issues. Each of the first negotiator 110 and the second negotiator 120 knows the domain 140 and attributes a utility value to combinations of the issues to be resolved. For example, where the domain 140 includes price and brand name and there are two options for each of price and brand name, the first negotiator 110 will have four different utility values, i.e., one for each possible combination. In some embodiments, the first negotiator 110 and the second negotiator 120 have utility values for less than all possible combinations. In some embodiments, the utility values assigned by the first negotiator 110 are different from the utility values assigned by the second negotiator 120 because the first and second negotiators have different priorities.

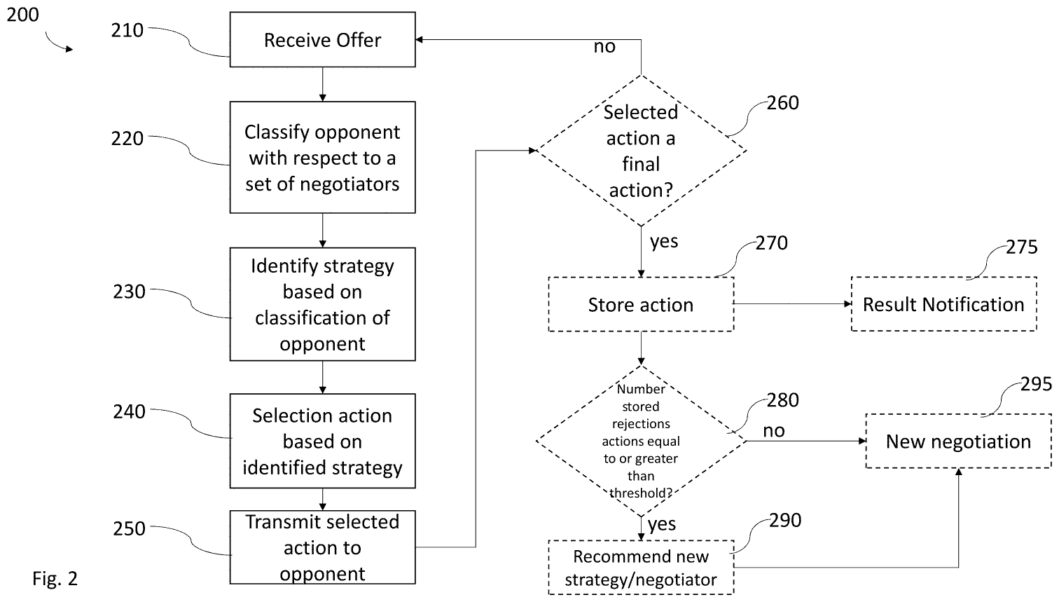

FIG. 2 is a flowchart of a method 200 of negotiation using an adaptive autonomous negotiation method in accordance with some embodiments. The method 200 is presented from one side of a negotiation. For example, in some embodiments, the method 200 describes the operations associated with the first negotiator 110 (FIG. 1).

The method 200 includes operation 210 in which an offer is received. In some embodiments, the offer is received wirelessly. In some embodiments, the offer is received by a wired connection. In some embodiments, the offer is received via the Internet. In some embodiments, the offer is an initial offer in a negotiation. In some embodiments, the offer is a counter-offer to a previous offer. In some embodiments, the system for implementing the method 200 includes a receiver for receiving the offer. The method 200 is described in a manner in which the received offer is neither a rejection nor an acceptance of a previous offer. One of ordinary skill in the art would understand that the current application is not limited to such an offer.

After the offer is received, the method 200 proceeds to operation 220 in which the opponent is classified with respect to a set of negotiators. The set of negotiators includes negotiators known to the AI implementing the method 200. The purpose of the classification is to determine which negotiator from the set of negotiators most closely resembles the opponent. The AI outputs a probability for each of the negotiators in the set of negotiators and selects the negotiator having the highest probability as being the negotiator which most closely resembles the opponent.

The opponent is classified based on the received offer. In some embodiments, the opponent is classified based on the received offer and at least one previous offer. In some embodiments, the opponent is classified based on the received offer and the previous four offers. In some embodiments, the opponent is classified based on the received offer and all previous offers from the opponent. As the number of offers being considered in the classification increases, an accuracy of the classification increases. However, as the number offers being considered in the classification increases, computing load on the AI also increases. In some embodiments, a user will predefine a maximum number of offers to be considered during the classification of the opponent.

For example, in some embodiments, in a system with three known negotiators and three known strategies; a maximum of ten total offers permitted in the negotiation; and a maximum number of offers to consider set to five, the classifier will determine three probabilities: p1 for the first known negotiator, p2 for the second known negotiator and p3 for the third known negotiator. The classifier will determine the probabilities based on the following input:

[U_{S}(w_{O}^{t-4}), U_{S}(w_{O}^{t-3}), U_{S}(w_{O}^{t-2}), U_{S}(w_{O}^{t-1}), U_{S}(w_{O}^{t})]

where Us is the utility function of the system implementing the method 200; wo is the offer from the opponent; and t is the number of the current offer. That is, wo^{t} is the most recent offer and wo^{t-4} is four offers prior to the most recent offer. By applying the utility function Us of the system to the opponents offers, the system is able to identify which of the known negotiators most closely resembles the opponent in order to more accurately predict the negotiation strategy, or strategies, used by the opponent. One of ordinary skill in the art would recognize that the utility function Us is applicable to different domains in addition to the domain of a current negotiation.

In the operation 230, a strategy is identified based on the classification of the opponent. The strategy is identified based on the probabilities determined in the operation 220. In some embodiments, each strategy is linked to a single negotiator; and the strategy linked to the negotiator with the highest probability is selected in operation 230. In some embodiments, a strategy is linked to more than one negotiator and that strategy is selected in response to any of the linked negotiators having the highest probability. In some embodiments, multiple strategies are linked to a single negotiator; and a strategy is selected from the multiple strategies in response to the single negotiator having the highest probability. In some embodiments, the strategy is selected from the multiple strategies based on a utility value of each of the multiple strategies.

Each of the strategies is trained using a deep reinforcement learning (DRL) algorithm. The DRL algorithm helps to train each strategy for use against a corresponding negotiator, i.e., the negotiator determined to most closely resemble the opponent in the operation 220. In some embodiments, the strategies the DRL algorithm also takes into account the state of the negotiation. The state of the negotiation is an indicator of how far into the negotiation is the offer being considered in the method 200. The state of the negotiation also takes into account the offers previously exchanged during the current negotiation. For example, if the protocol indicates a maximum number of steps of offers, then the state of the negotiation is a ratio between the number of the current offer and the maximum number of offers, in some embodiments. In some embodiments where the protocol indicates a maximum duration of the negotiation, the state of the negotiation is a ratio between the current duration of the negotiation and the maximum duration.

Returning to the example of three known negotiators and three known strategies and having from above, in some embodiments, an input for the DRL algorithm for a strategy is:

$$[ \frac{t}{T} , {U}_{S} ( {w}_{O}^{t - 2} ) , {U}_{S} ( {w}_{S}^{t - 2} ) , {U}_{S} ( {w}_{O}^{t - 1} ) , {U}_{S} ( {w}_{S}^{t - 1} ) , {U}_{S} ( {w}_{O}^{t} ) ]$$

where t is the number of the current offer, T is the maximum total offers permitted, Us is the utility function of the system implementing the method 200, wo is the offer from the opponent; and ws is the offer from the system implementing the method 200. In some embodiments, the DRL algorithm considers the state of the negotiation, the most recent offer from the opponent as well as the preceding two offers from each of the opponent and the system. By using this information the strategies are adapted to respond to changes in the offer strategy of the opponent and to determine how the opponent is responding to offers from the system. In some embodiments, each strategy is linked to a single negotiator.

The action, i.e., response, associated with each strategy is determined based on a utility value of the action. In some embodiments, the utility value of the action is determined using an action space:

ur<us^{t+1}≤1

where ur is the reservation utility value, and us^{t+1} is the utility value of the action. The reservation utility value is the value for the system if no agreement is reached. Using this criteria, the method 200 helps to ensure that the value of any action taken is greater than a value should the negotiation fail.

In some embodiments, the operation 230 is not performed in every iteration, i.e., in response to every offer from the opponent, of the method 200. For example, in some embodiments, if the negotiator determined in the operation 220 is unchanged from a previous iteration, then the strategy from the previous iteration is maintained and the operation 230 is omitted. In some embodiments, the operation 230 is performed after a set number of iterations; in response to a change in the negotiator identified in the operation 220; or based on the state of the negotiation.

In operation 240, an action based on the identified strategy is selected. The action is determined by an inverse mapping of the strategy. In some embodiments, the action is an acceptance of the offer, a counter-offer, or a rejection of the offer and termination of the negotiation.

In operation 250, the action is transmitted to the opponent. In some embodiments, the action is transmitted to the opponent using wireless communication. In some embodiments, the action is transmitted to the opponent using a wired connection. In some embodiments, the action is transmitted to the opponent via the Internet. In some embodiments, confirmation of the transmittal of the action to the opponent is sent to the user. In some embodiments, the confirmation is a notification, such as a visual or audio notification, sent to the user. In some embodiments, the transmittal of the action prompts a notification, such as a visual or audio notification, of the opponent (or a user of the opponent). In some embodiments, the system for implementing the method 200 includes transmitter for transmitting the action to the opponent.

The method 200 includes optional operations 260-295. Optional operations 260-295 help to identify whether a new strategy or negotiator is recommended in order to help improve results of the system implementing the method 200. In some embodiments, optional operations 260-295 are omitted.

In optional operation 260, a determination is made regarding whether the selected action is a final action. A final action is an acceptance of the offer or a rejection of the offer where the negotiation is terminated. In response to a determination that the selected action is a not a final action, the method 200 returns to the operation 210 and waits for the next offer from the opponent. In response to a determination that the selected action is a final action, the method 200 proceeds to operation 270.

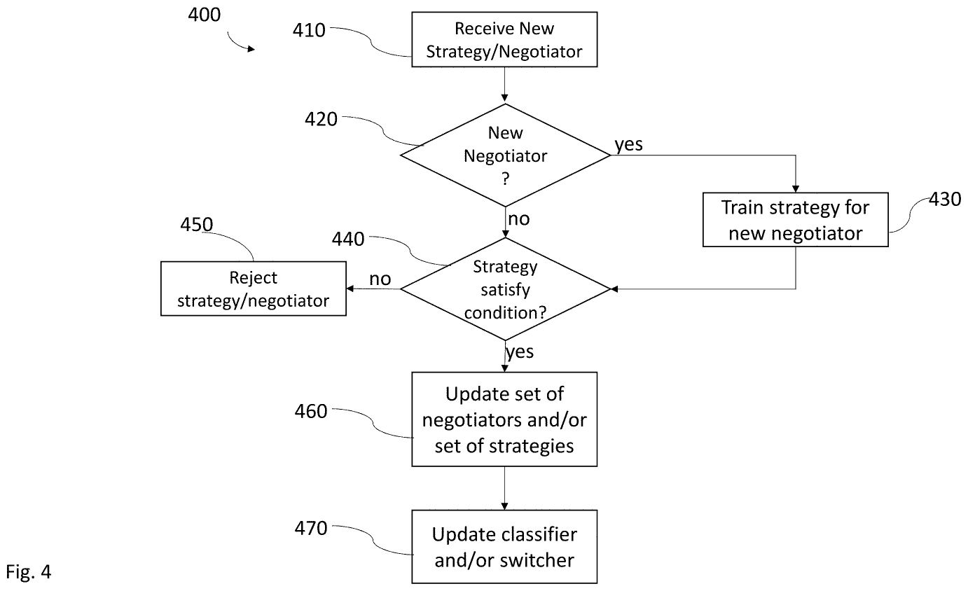

In the optional operation 270, the final action is stored in a memory, e.g., the memory 604 (FIG. 4). The memory is accessible by the user so that the user is able to review results of negotiations. In some embodiments where the final action is acceptance, the values for the issues to be resolved are stored with the final action. In some embodiments where the final action is a rejection, the last action prior to the rejection is also stored with the final action. In some embodiments, a history of actions for the negotiation are stored in the memory along with the final action in order to allow the user to review the history of the negotiation.

In optional operation 275, the user is notified of the result of the negotiation. In some embodiments, the user is notified using a visual or audio notification. In some embodiments, an alert is generated and transmitted to a mobile device of the user in order to notify the user of the result of the negotiation.

In optional operation 280, a determination is made regarding whether a number of stored rejection actions is equal to or greater than a threshold. In some embodiments, the threshold is a predefined number. In some embodiments, the predefined number is provided by the user. In some embodiments, the threshold is a predefined number of consecutive negotiations resulting in rejection of an offer. In some embodiments, the predefined number is provided by the user. In some embodiments, the threshold is a predefined number of negotiations resulting in rejection within a predefined time period. In some embodiments, the predefined number is provided by the user. In some embodiments, the predefined time period is provided by the user. In some embodiments, the predefined time period is a day, a week or another suitable time period. By determining whether negotiations are resulting in a large number of failures, i.e., rejections of offers, the method 200 helps to identify whether the current negotiators and strategies are producing acceptable results. In response to the number of stored rejections being equal to or greater than the threshold, the method proceeds to optional operation 290. In response to the number of stored rejections being less than the threshold, the method 200 proceeds to optional operation 295.

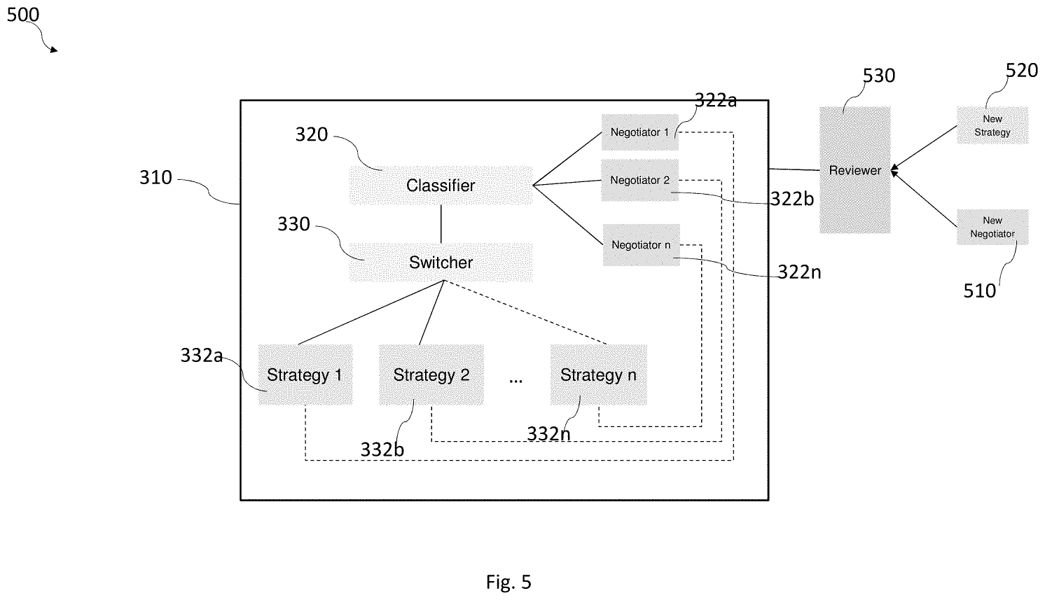

In the optional operation 290, a recommendation is generated to seek a new strategy and/or negotiator. In some embodiments, the system implementing the method 200 automatically checks a database to determine whether any new strategies or negotiators are available for potential inclusion. Details of inclusion of new strategies or negotiators are discussed with respect to FIGS. 4 and 5 below. In some embodiments, in response to a determination that no new strategies or negotiators are available for potential inclusion into the system, the method 200 notifies the user recommending that new strategies or negotiators be developed. In some embodiments, the user is notified using a visual or audio notification. In some embodiments, an alert is generated and transmitted to a mobile device of the user in order to notify the user for prompting development of new strategies or negotiators. In some embodiments, the system implementing the method 200 prompts the user to recommend development of a new strategy or negotiator regardless of whether new strategies or negotiators are available. In some embodiments, the system implementing the method 200 notifies a user when the database is accessed in a search for new strategies or negotiators.

In the optional operation 295, a new negotiation is started. In some embodiments, the new negotiation is with a same opponent as the preceding negotiation. In some embodiments, the new negotiation is with a different opponent from the preceding negotiation.

In some embodiments, the method 200 includes at least one additional operation. For example, in some embodiments, the method 200 includes transmitting a notification to the user in response to the state of a negotiation reaching a threshold state. In some embodiments, at least one operation of the method 200 is omitted. For example, in some embodiments, the operation 275 is omitted and the result of the user is not notified regarding the result of the negotiation. In some embodiments, an order of operations of the method 200 changes. For example, in some embodiments, the operation 275 occurs prior to the operation 270. In some embodiments, at least two operations of the method 200 are performed simultaneously. For example, in some embodiments, the operations 270 and 275 are performed simultaneously.

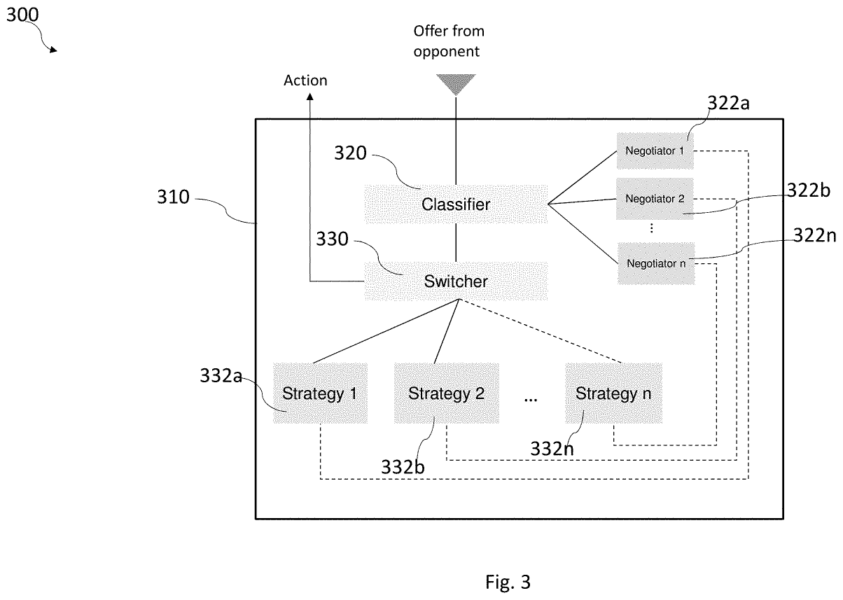

FIG. 3 is a schematic view of an adaptive autonomous negotiation system 300 in accordance with some embodiments. In some embodiments, the system 300 is usable to implement the method 200 (FIG. 2). In some embodiments, the system 300 is usable to implement a method different from the method 200. The system 300 includes a computing device 310. The computing device 310 includes at least a processor and a memory. In some embodiments, the computing device 310 is a single device. In some embodiments, the computing device 310 includes multiple devices. In some embodiments, the computing device 310 includes a receiver, a transmitter and/or a transceiver for transmitting and receiving information between devices and/or to or from an opponent. In some embodiments, the computing device 310 is capable of wireless communication. In some embodiments, the computing device 310 is capable of wired communication. In some embodiments, the computing device 310 is capable of communication via the Internet.

The computing device includes a classifier 320 configured to analyze an offer received from the opponent. In some embodiments, the offer from the opponent is received by a receiver in the computing device 310 and transferred to the classifier 320 for analysis.

The computing device 310 further includes a set of negotiators, i.e., negotiator 322a, negotiator 322b and negotiator 322n, collectively called negotiators 322. In some embodiments, the negotiators 322 are stored in a memory of the computing device 310. In some embodiments, the negotiators 322 are stored in a separate device accessible by the computing device 310.

The classifier 320 is configured to analyze the offer in order to determine which of the negotiators 322 most closely resembles the opponent. In some embodiments, the classifier 320 is configured to implement the operation 220 of the method 200 (FIG. 2). In some embodiments, the classifier 320 determines which of the negotiators 322 most closely resembles the opponent using a process different from the operation 220.

The computing device 310 further includes a switcher 330. The switcher 330 is configured to receive an output of the classifier 320. The switcher 330 is configured to use the output from the classifier 320 in order to determine a strategy for responding to the received offer from the opponent.

The computing device 310 further includes a set of strategies, i.e., strategy 332a, strategy 332b and strategy 332n, collectively called strategies 332. In some embodiments, the strategies 332 are stored in a memory of the computing device 310. In some embodiments, the strategies 332 are stored in a separate device accessible by the computing device 310. In system 300, each of the strategies 332 is associated with a corresponding one of the negotiators 322, as indicated by the dashed lines in FIG. 3. In some embodiments, at least one of the strategies 332 is linked to more than one negotiators 322. In some embodiments, at least one of the negotiators 322 is linked to more than one of the strategies 332.

The switcher 330 is configured to analyze the output from the classifier 320 in order to determine which of the strategies 332 to use in responding to the received offer from the opponent. In some embodiments, the switcher 330 is configured to implement the operation 230 of the method 200 (FIG. 2). In some embodiments, the switcher 330 determines which of the strategies 332 to use for responding to the received offer from the opponent using a process different from the operation 230.

The switcher 330 is also configured to determine an action for responding to the offer from the opponent based on the selected one of the strategies. In some embodiments, the switcher 330 is configured to implement the operation 240 of the method 200 (FIG. 2). In some embodiments, the switcher 330 is configured to determine the action using a process different from the operation 240.

The switcher 330 is configured to output the action determined based on the selected one of the strategies 332. In some embodiments, the switcher 330 is connected to a transmitter for transmitting the action to the opponent. In some embodiments, the switcher 330 is configured to implement the operation 250 of the method 200 (FIG. 2). In some embodiments, the switcher 330 is configured to transmit the action using a process different from the operation 250.

FIG. 4 is a flowchart of a method 400 of adding a new negotiator or a new strategy to an adaptive autonomous negotiation system in accordance with some embodiments. In some embodiments, the method 400 is used to evaluate new strategies or negotiators pursuant to the operation 290 of the method 200 (FIG. 2). In some embodiments, the method 400 is capable of implementation separate from the method 200. In some embodiments, a same system is usable for implementing both the method 400 and the method 200 (FIG. 2).

In operation 410 a new strategy or negotiator is received. In some embodiments, the new strategy or negotiator is received from the user. In some embodiments, the new strategy or negotiator is accessed from a database. In some embodiments, the new strategy or negotiator is received via a wireless communication. In some embodiments, the new strategy or negotiator is received via wired communication. In some embodiments, the new strategy or negotiator is received via the Internet.

In some embodiments, the operation 410 is initiated in response to the operation 290 of the method 200 (FIG. 2). In some embodiments, the operation 410 is initiated in response to an input from the user. In some embodiments, the operation 410 is automatically initiated by a system for implementing the method 400. In some embodiments, the operation 410 is automatically initiated following a preset duration of operation of the system. In some embodiments, the preset duration is determined by the user. In some embodiments, the operation 410 is automatically initiated following a predetermined number of negotiations. In some embodiments, the user determines the predetermined number of negotiations. In some embodiments, the operation 410 is automatically initiated in response to detection of an available new strategy or negotiation. In some embodiments, the system for implementing the method 400 receives a notification from an external system when a new strategy or negotiator is available.

In operation 420 a determination is made regarding whether the new strategy or negotiator is a new negotiator. In some embodiments, the determination is made based on whether the new strategy or negotiator is a multiple component element. In some embodiments, the determination is made based on data stored within the new strategy or negotiators. In response to a determination that the new strategy or negotiator is a negotiator, the method 400 proceeds to operation 430. In response to a determination that the new strategy or negotiator is a strategy, the method 400 proceeds to operation 440.

In the operation 430, a new strategy is trained for the new negotiator. In some embodiments, the new strategy is trained using a DRL algorithm, similar to the DRL training described above. In some embodiments, the new strategy is trained using a different algorithm. An output of the operation 430 is a trained strategy.

In the operation 440 a determination is made regarding whether the new strategy satisfies a predetermined condition. In some embodiments, the predetermined condition is set by the user. In some embodiments, the predetermined condition is whether the new strategy produces a superior result to at least one other strategy within the system implementing the method 400. In some embodiments, the determination includes simulating a negotiation using the new strategy based training data in order to produce a result. The result from the simulated negotiation is then compared to a result from at least one strategy within the system for implementing the method 400. If the result from the simulated negotiation using the new strategy produces a superior result, then the new strategy is included in the system for implementing the method 400. In some embodiments, the superiority of the result is determined based on a utility value of the final decision of the simulated negotiation.

In response to a determination that the new strategy fails to satisfy the condition, the method 400 proceeds to operation 450. In response to a determination that the new strategy satisfies the condition, the method 400 proceeds to operation 460.

In the operation 450, the new strategy or negotiator is rejected and is not included in the system for implementing the method 400. In some embodiments, the system for implementing the method 400 notifies the user in response to rejection of the new strategy or negotiator. In some embodiments, the user is notified using a visual or audio notification. In some embodiments, an alert is generated and transmitted to a mobile device of the user in order to notify the user for prompting review of the new strategy or negotiator. In some embodiments, the notification includes information related to the results of the simulated negotiation.

In the operation 460, the system for implementing the method 400 is updated to include the new strategy or negotiator. In some embodiments, the updating includes storing of the new strategy or negotiator in the system. In some embodiments, the updating includes storing the new strategy or negotiator in an external device, such as a database, accessible by the system.

In operation 470, the classifier and/or switcher of the system for implementing the method 400 is updated. The classifier and switcher are both updated in response to inclusion of a new negotiator. The switcher is updated in response to the inclusion of a new strategy. In some embodiments, where a new negotiator is introduced, a strategy corresponding to the strategy produced in the operation 430 is also introduced. In some embodiments, the updating includes linking the new strategy to at least one existing negotiator. In some embodiments, the updating includes linking the new negotiator to at least one existing strategy. Following the operation 470, the new strategy or negotiator is usable during future negotiations.

In some embodiments, the method 400 includes at least one additional operation. For example, in some embodiments, the method 400 includes transmitting a notification to the user in response to the strategy satisfying the condition in the operation 440. In some embodiments, at least one operation of the method 400 is omitted. For example, in some embodiments, the operation 440 is omitted and the new strategy or negotiator is automatically included in the system. In some embodiments, an order of operations of the method 400 changes. For example, in some embodiments, the operation 470 occurs prior to the operation 460. In some embodiments, at least two operations of the method 400 are performed simultaneously. For example, in some embodiments, the operations 460 and 470 are performed simultaneously.

FIG. 5 is a schematic view of an adaptive autonomous negotiation system 500 in accordance with some embodiments. The system 500 is similar to the system 300 (FIG. 3). In comparison with the system 300, the system 500 includes a new negotiator 510, a new strategy 520 and a reviewer 530. In some embodiments, the system 500 is usable to implement the method 200 (FIG. 2) and/or the method 400 (FIG. 4). In some embodiments, the system 500 is usable to implement a method different from the method 200 or the method 400. In some embodiments, the system 500 includes only one of the new negotiator 510 or the new strategy 520.

The new negotiator 510 and/or the new strategy 520 are accessible by the computing device 310. In some embodiments, the new negotiator 510 and/or the new strategy 520 are stored within the computing device 310. In some embodiments, the new negotiator 510 and/or the new strategy 520 is stored in an external device, such as a database, accessible by the computing device 310.

The reviewer 530 is usable to determine whether the new negotiator 510 and/or the new strategy 520 should be included in the computing device 310. In some embodiments, the reviewer 530 implements at least one of the operations 420, 430, 440 or 450 of the method 400 (FIG. 4). In some embodiments, the reviewer 530 is part of the computing device 310. In some embodiments, the reviewer 530 is separate from the computing device 310.

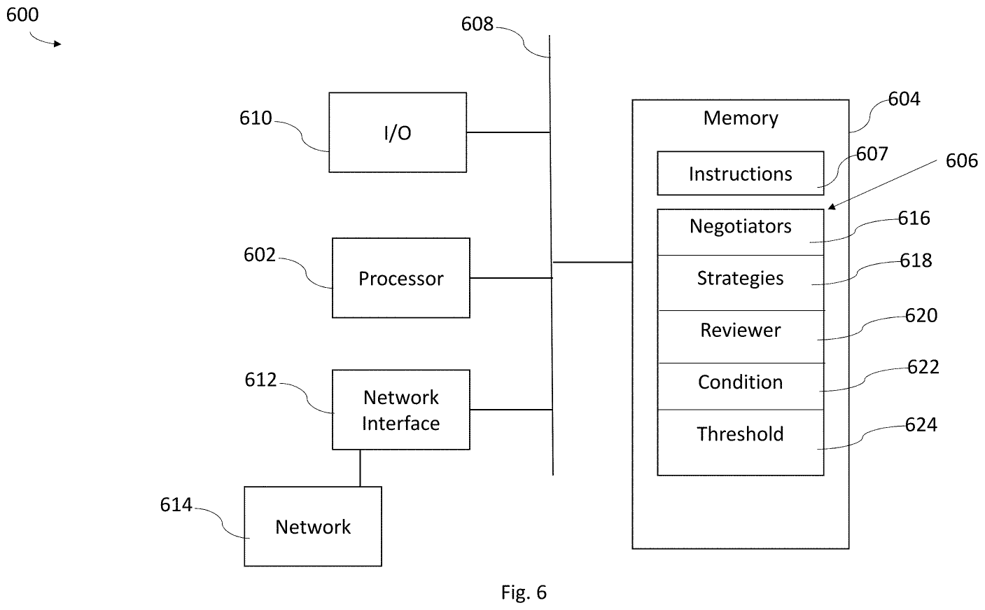

FIG. 6 is a block diagram of a system 600 for adaptive autonomous negotiation in accordance with some embodiments. The system 600 includes a hardware processor 602 and a non-transitory, computer readable storage medium 604 encoded with, i.e., storing, the computer program code 606, i.e., a set of executable instructions. Computer readable storage medium 604 is also encoded with instructions 607 for interfacing with external devices, such as databases. The processor 602 is electrically coupled to the computer readable storage medium 604 via a bus 608. The processor 602 is also electrically coupled to an I/O interface 610 by bus 608. A network interface 612 is also electrically connected to the processor 602 via bus 608. Network interface 612 is connected to a network 614, so that processor 602 and computer readable storage medium 604 are capable of connecting to external elements via network 614. The processor 602 is configured to execute the computer program code 606 encoded in the computer readable storage medium 604 in order to cause system 600 to be usable for performing a portion or all of the operations as described in method 200 (FIG. 2) or method 400 (FIG. 4). In some embodiments, the system 600 is usable as the system 300 (FIG. 3) and/or the system 500 (FIG. 5).

In some embodiments, the processor 602 is a central processing unit (CPU), a multi-processor, a distributed processing system, an application specific integrated circuit (ASIC), and/or a suitable processing unit.

In some embodiments, the computer readable storage medium 604 is an electronic, magnetic, optical, electromagnetic, infrared, and/or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 604 includes a compact disk-read only memory (CD-ROM), a compact disk-read/write (CD-R/W), and/or a digital video disc (DVD).

In some embodiments, the storage medium 604 stores the computer program code 606 configured to cause system 600 to perform method 200 or method 400. In some embodiments, the storage medium 604 also stores information needed for performing the method 200 or 400 as well as information generated during performing the method 200 or 400, such as a negotiators parameter 616, a strategies parameter 618, a reviewer parameter 620, a condition parameter 622, a threshold parameter 624 and/or a set of executable instructions to perform the operation of method 200 or 400.

In some embodiments, the storage medium 604 stores instructions 607 for interfacing with external devices. The instructions 607 enable processor 602 to communicate with external devices to effectively implement method 200 or method 400.

System 600 includes I/O interface 610. I/O interface 510 is coupled to external circuitry. In some embodiments, I/O interface 610 includes a keyboard, keypad, mouse, trackball, trackpad, and/or cursor direction keys for communicating information and commands to processor 602.

System 600 also includes network interface 612 coupled to the processor 602. Network interface 612 allows system 600 to communicate with network 614, to which one or more other computer systems are connected. Network interface 612 includes wireless network interfaces such as BLUETOOTH, WIFI, WIMAX, GPRS, or WCDMA; or wired network interface such as ETHERNET, USB, or IEEE-1394. In some embodiments, method 200 or 400 is implemented in two or more systems 600, and information is exchanged between different systems 600 via network 614.

System 600 is configured to receive information related to negotiators through I/O interface 610 and/or network interface 612. The information is transferred to processor 602 via bus 608 to determine the negotiators for inclusion in the system 600. The negotiators are then stored in computer readable medium 604 as negotiators parameter 616. System 600 is configured to receive information related to strategies through I/O interface 610 and/or network interface 612. The information is transferred to processor 602 via bus 608 to determine the strategies for inclusion in the system 600. The strategies are then stored in computer readable medium 604 as strategies parameter 618. System 600 is configured to receive information related to the reviewer through I/O interface 610 and/or network interface 612. The information is transferred to processor 602 via bus 608 to implement the reviewer for inclusion in the system 600. The reviewer information is then stored in computer readable medium 604 as reviewer parameter 620. System 600 is configured to receive information related to a condition for including a new strategy or negotiator in the system 600 through I/O interface 610 and/or network interface 612. The information is transferred to processor 602 via bus 608. The condition is then stored in computer readable medium 604 as condition parameter 622. System 600 is configured to receive information related to a threshold for determining whether to recommend addition of a new strategy or new negotiator through I/O interface 610 and/or network interface 612. The information is transferred to processor 602 via bus 608. The threshold information then stored in computer readable medium 604 as threshold parameter 624.

An aspect of this description relates to a method of adaptive autonomous negotiation. The method includes receiving a first offer, using a receiver. The method further includes automatically identifying a first negotiator of a plurality of negotiators, using a processor, based on the received first offer, wherein the plurality of negotiators is stored in a memory. The method further includes automatically selecting a first strategy from a plurality of strategies based on the identified first negotiator, wherein the plurality of strategies is stored in the memory. The method further includes automatically selecting an action for responding to the first offer based on the selected first strategy, wherein automatically selected the action includes performing an inverse mapping on the selected first strategy. The method further includes automatically transmitting the selected action, using a transmitter. In some embodiments, the method further includes training each of the plurality of strategies using a deep reinforcement learning (DRL) algorithm based on a corresponding negotiator of the plurality of negotiators. In some embodiments, the method further includes receiving a second offer; automatically identifying a second negotiator of the plurality of negotiators based on the received second offer; maintaining the first strategy in response to the second negotiator being a same negotiator as the first negotiator; and automatically selecting a second strategy of the plurality of strategies based on the identified second negotiator in response to a determination that the second negotiator is different from the first negotiator. In some embodiments, the method further includes storing results from a plurality of negotiations in the memory; determining whether a number of rejection actions of the stored results is equal to or greater than a threshold; and recommending adding a new strategy to the plurality of strategies or a new negotiator to the plurality of negotiators in response to the number of rejection actions being equal to or greater than the threshold. In some embodiments, the method further includes receiving a new negotiator; training a new strategy based on the received new negotiator, wherein training the new strategy comprises training the new strategy using a DRL algorithm; comparing the trained new strategy against at least one strategy of the plurality of strategies using a simulated negotiation; and adding the new negotiator to the plurality of negotiators in response to a determination that a result of the trained new strategy in the simulated negotiation is superior to the at least one strategy. In some embodiments, the method further includes receiving a new strategy; comparing the new strategy against at least one strategy of the plurality of strategies using a simulated negotiation; and adding the new strategy to the plurality of strategies in response to a determination that a result of the new strategy in the simulated negotiation is superior to the at least one strategy.

An aspect of this description relates to an adaptive autonomous negotiation system. The system includes a receiver configured to receive a first offer. The system further includes a non-transitory computer readable medium configured to store a plurality of negotiators and a plurality of strategies, wherein the non-transistor computer readable medium is further configured to store instructions. The system further includes a processor. The processor is configured to execute the instructions for: automatically identifying a first negotiator of the plurality of negotiators based on the received first offer; automatically selecting a first strategy from a plurality of strategies based on the identified first negotiator; automatically selecting an action for responding to the first offer based on the selected first strategy; and automatically instructing a transmitter to transmit the selected action. In some embodiments, wherein the receiver is further configured to receive a second offer, and the processor is further configured to execute the instructions for: automatically identifying a second negotiator of the plurality of negotiators based on the received second offer; maintaining the first strategy in response to the second negotiator being a same negotiator as the first negotiator; and automatically selecting a second strategy of the plurality of strategies based on the identified second negotiator in response to a determination that the second negotiator is different from the first negotiator. In some embodiments, the processor is configured to execute the instructions for: instructing the non-transitory computer readable medium to store results from a plurality of negotiations; determining whether a number of rejection actions of the stored results is equal to or greater than a threshold; and generating a recommendation for adding a new strategy to the plurality of strategies or a new negotiator to the plurality of negotiators in response to the number of rejection actions being equal to or greater than the threshold. In some embodiments, the receiver is configured to receive a new negotiator, and the processor is further configured to execute the instructions for: training a new strategy based on the received new negotiator; comparing the trained new strategy against at least one strategy of the plurality of strategies using a simulated negotiation; and adding the new negotiator to the plurality of negotiators in response to a determination that a result of the trained new strategy in the simulated negotiation is superior to the at least one strategy.

An aspect of this description relates to a method of adaptive autonomous negotiation. The method includes receiving a first offer, using a receiver. The method further includes automatically identifying a plurality of negotiators from a memory based on the received first offer. The method further includes automatically selecting a plurality of strategies from the memory based on the identified plurality of negotiators. The method further includes automatically selecting a plurality of weights for the each of the selected plurality of strategies based on the identified plurality of negotiators. The method further includes automatically selecting an action for responding to the first offer based on the selected plurality of strategies, wherein automatically selecting the action includes performing a weighted summation of an inverse mapping on the selected plurality of strategies using the calculated plurality of weights. The method further includes automatically transmitting the selected action, using a transmitter. In some embodiments, automatically identifying the plurality of negotiators includes assigning a probability to each negotiator of the identified plurality of negotiators. In some embodiments, automatically selecting the plurality of strategies includes automatically selecting the plurality of strategies based on the probability of each corresponding negotiator of the identified plurality of negotiators. In some embodiments, the method further includes receiving a second offer; automatically identifying a second plurality of negotiators from the memory based on the received second offer; maintaining the selected plurality of strategies in response to the second plurality of negotiators being equal to the identified plurality of negotiators; and automatically selecting a second plurality of strategies based on the second plurality of negotiators in response to a determination that the second plurality of negotiators is different from the identified plurality of negotiators. In some embodiments, the method further includes using a deep reinforcement learning (DRL) algorithm to train the negotiation strategy, and training the DRL algorithm using a state of the negotiation. In some embodiments, the state of the negotiation is based on at least one of how far into the negotiation is the first offer considered or a previously received offer. In some embodiments, the method further includes sending confirmation of the transmittal of the action to the opponent, wherein the confirmation is a notification comprising a visual or audio notification. In some embodiments, the method further includes storing results from a plurality of negotiations in the memory; determining whether a number of rejection actions of the stored results is equal to or greater than a threshold; and recommending adding a new strategy to the plurality of strategies or a new negotiator to the memory in response to the number of rejection actions being equal to or greater than the threshold. In some embodiments, the method further includes receiving a new negotiator; training a new strategy based on the received new negotiator, wherein training the new strategy comprises training the new strategy using a DRL algorithm; comparing the trained new strategy against at least one strategy of the plurality of strategies using a simulated negotiation; and adding the new negotiator to the memory in response to a determination that a result of the trained new strategy in the simulated negotiation is superior to the at least one strategy. In some embodiments, the method further includes receiving a new strategy; comparing the new strategy against at least one strategy of the plurality of strategies using a simulated negotiation; and adding the new strategy to the memory in response to a determination that a result of the new strategy in the simulated negotiation is superior to the at least one strategy.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of adaptive autonomous negotiation, the method comprising:
receiving a first offer, using a receiver;
automatically identifying a first negotiator of a plurality of negotiators, using a processor, based on the received first offer, wherein the plurality of negotiators is stored in a memory;
automatically selecting a first strategy from a plurality of strategies based on the identified first negotiator, wherein the plurality of strategies is stored in the memory;
automatically selecting an action for responding to the first offer based on the selected first strategy, wherein automatically selected the action comprises performing an inverse mapping on the selected first strategy; and
automatically transmitting the selected action, using a transmitter.

2. The method according to claim 1, further comprising training each of the plurality of strategies using a deep reinforcement learning (DRL) algorithm based on a corresponding negotiator of the plurality of negotiators.

3. The method according to claim 1, further comprising:
receiving a second offer;
automatically identifying a second negotiator of the plurality of negotiators based on the received second offer;
maintaining the first strategy in response to the second negotiator being a same negotiator as the first negotiator; and
automatically selecting a second strategy of the plurality of strategies based on the identified second negotiator in response to a determination that the second negotiator is different from the first negotiator.

4. The method according to claim 1, further comprising:
storing results from a plurality of negotiations in the memory;
determining whether a number of rejection actions of the stored results is equal to or greater than a threshold; and
recommending adding a new strategy to the plurality of strategies or a new negotiator to the plurality of negotiators in response to the number of rejection actions being equal to or greater than the threshold.

5. The method according to claim 1, further comprising:
receiving a new negotiator;
training a new strategy based on the received new negotiator, wherein training the new strategy comprises training the new strategy using a DRL algorithm;
comparing the trained new strategy against at least one strategy of the plurality of strategies using a simulated negotiation; and
adding the new negotiator to the plurality of negotiators in response to a determination that a result of the trained new strategy in the simulated negotiation is superior to the at least one strategy.

6. The method according to claim 1, further comprising:
receiving a new strategy;
comparing the new strategy against at least one strategy of the plurality of strategies using a simulated negotiation; and
adding the new strategy to the plurality of strategies in response to a determination that a result of the new strategy in the simulated negotiation is superior to the at least one strategy.

7. An adaptive autonomous negotiation system, the system comprising:
a receiver configured to receive a first offer;
a non-transitory computer readable medium configured to store a plurality of negotiators and a plurality of strategies, wherein the non-transistor computer readable medium is further configured to store instructions; and
a processor configured to execute the instructions for:
automatically identifying a first negotiator of the plurality of negotiators based on the received first offer;
automatically selecting a first strategy from a plurality of strategies based on the identified first negotiator;
automatically selecting an action for responding to the first offer based on the selected first strategy; and
automatically instructing a transmitter to transmit the selected action.

8. The system according to claim 7, wherein the receiver is further configured to receive a second offer, and the processor is further configured to execute the instructions for:
automatically identifying a second negotiator of the plurality of negotiators based on the received second offer;
maintaining the first strategy in response to the second negotiator being a same negotiator as the first negotiator; and
automatically selecting a second strategy of the plurality of strategies based on the identified second negotiator in response to a determination that the second negotiator is different from the first negotiator.

9. The system according to claim 7, wherein the processor is configured to execute the instructions for:
instructing the non-transitory computer readable medium to store results from a plurality of negotiations;
determining whether a number of rejection actions of the stored results is equal to or greater than a threshold; and
generating a recommendation for adding a new strategy to the plurality of strategies or a new negotiator to the plurality of negotiators in response to the number of rejection actions being equal to or greater than the threshold.

10. The system according to claim 7, wherein the receiver is configured to receive a new negotiator, and the processor is further configured to execute the instructions for:
training a new strategy based on the received new negotiator;
comparing the trained new strategy against at least one strategy of the plurality of strategies using a simulated negotiation; and
adding the new negotiator to the plurality of negotiators in response to a determination that a result of the trained new strategy in the simulated negotiation is superior to the at least one strategy.

11. A method of adaptive autonomous negotiation, the method comprising:
receiving a first offer, using a receiver;
automatically identifying a plurality of negotiators from a memory based on the received first offer;
automatically selecting a plurality of strategies from the memory based on the identified plurality of negotiators;
automatically selecting a plurality of weights for the each of the selected plurality of strategies based on the identified plurality of negotiators;
automatically selecting an action for responding to the first offer based on the selected plurality of strategies, wherein automatically selecting the action comprises performing a weighted summation of an inverse mapping on the selected plurality of strategies using the calculated plurality of weights; and
automatically transmitting the selected action, using a transmitter.

12. The method of claim 11, wherein automatically identifying the plurality of negotiators comprises assigning a probability to each negotiator of the identified plurality of negotiators.

13. The method of claim 12, wherein automatically selecting the plurality of strategies comprises automatically selecting the plurality of strategies based on the probability of each corresponding negotiator of the identified plurality of negotiators.

14. The method according to claim 11, further comprising:
receiving a second offer;
automatically identifying a second plurality of negotiators from the memory based on the received second offer;
maintaining the selected plurality of strategies in response to the second plurality of negotiators being equal to the identified plurality of negotiators; and
automatically selecting a second plurality of strategies based on the second plurality of negotiators in response to a determination that the second plurality of negotiators is different from the identified plurality of negotiators.

15. The method of claim 11, further comprising:
using a deep reinforcement learning (DRL) algorithm to train the negotiation strategy, and
training the DRL algorithm using a state of the negotiation.

16. The method of claim 15, wherein the state of the negotiation is based on at least one of how far into the negotiation is the first offer considered or a previously received offer.

17. The method of claim 11, further comprising:
sending confirmation of the transmittal of the action to the opponent, wherein the confirmation is a notification comprising a visual or audio notification.

18. The method according to claim 11, further comprising:
storing results from a plurality of negotiations in the memory;
determining whether a number of rejection actions of the stored results is equal to or greater than a threshold; and
recommending adding a new strategy to the plurality of strategies or a new negotiator to the memory in response to the number of rejection actions being equal to or greater than the threshold.

19. The method according to claim 11, further comprising:
receiving a new negotiator;
training a new strategy based on the received new negotiator, wherein training the new strategy comprises training the new strategy using a DRL algorithm;
comparing the trained new strategy against at least one strategy of the plurality of strategies using a simulated negotiation; and
adding the new negotiator to the memory in response to a determination that a result of the trained new strategy in the simulated negotiation is superior to the at least one strategy.

20. The method according to claim 11, further comprising:
receiving a new strategy;
comparing the new strategy against at least one strategy of the plurality of strategies using a simulated negotiation; and
adding the new strategy to the memory in response to a determination that a result of the new strategy in the simulated negotiation is superior to the at least one strategy.
